(19) United States
(12) Patent Application Publication
(10) Pub. No.: US 2009/0132962 A1
(43) Pub. Date: May 21, 2009

(54) Method and System for Configuring a Monitor

(75) Inventor: Albertus Soemantri, Friedberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Fujitsu Siemens Computers GmbH, Munchen (DE)

(21) Appl. No.: 12/282,294

(22) PCT Filed: Feb. 2, 2007
(86) PCT No.: PCT/DE2007/000197

§ 371 Date: Jan. 21, 2009

(30) Foreign Application Priority Data
Mar. 9, 2006 (DE) 10 2006 010 980.5

(51) Int. Cl. G06F 3/048; G06F 3/00; G06F 17/00

(52) U.S. Cl. 715/810; 710/5; 710/8; 345/418

(57) ABSTRACT

A method and a system for configuring a monitor, and also to a monitor, a computer and a graphics card which are able to be used to carry out the method for configuring a monitor. Following operation of an input facility (14) on a monitor (10), a control signal is generated by a control signal generator (11) in the monitor (10). The control signal is transferred from the monitor (10) to a computer (1) and is detected there by a control signal detector (3) in the computer (1). Next, a configuration program (7), executed by the computer (1), for the remote configuration of the monitor (10) is activated by the computer (1). The control signal which is transferred from the monitor (10) to the computer (1) and which is detected there allows the configuration of the monitor (10) to be activated in the customary manner, namely by operating the input facility (14) on the monitor (10), even in the case of remote configuration.

The invention relates to a method and a system for configuring a monitor, and also to a monitor, a computer and a graphics card which can be used to carry out the method for configuring a monitor.

Computer monitors, subsequently called monitors for short, can be configured by the user to suit the computer to which they are connected or to suit the ambient light conditions or the user's preferences. Typically, such configuration involves setting brightness values, contrast values, colour display parameters, image sizes and position etc. Usually, one or more keys are provided on the monitor for configuration and can be used to display and control a configuration menu on the monitor's screen (OSD—On Screen Display).

Alternatively, it is known practice to carry out the monitor configuration using a configuration program (Display View Software) executed on the computer. Monitor settings changed during such remote configuration of the monitor are transferred from the computer to the monitor via a control line. The control signal is transferred usually by using a serial connection standardized by the VESA (Video Electronics Standards Association) organization, said serial connection being called a DDC (Display Data Channel). Many of the usual interface specifications for connecting monitors to computers, e.g. the analogue VGA (Video Graphics Adapter) interface or the digital HDMI (High Definition Multimedia Interface) or DVI (Digital Video Interface) support the transfer of the control signal on the basis of the VESA-DDC standard.

In comparison with configuration inside the monitor using the keys provided for this purpose and the OSD menu, remote configuration of the monitor from the computer makes operation significantly more convenient for the user. The keyboard and mouse provide more convenient input devices than the usually small keys on the monitor for operating the OSD menu. In addition, the computer can easily be used to store and manage various configuration settings. Thus, by way of example, various users can store various monitor configurations for different applications, it being possible to change quickly between said monitor configurations manually or automatically.

One drawback of remote configuration of the monitor using the computer is based on the user's habits. The user is accustomed to making settings for his monitor on the monitor itself. Alternative or exclusive remote configuration of the monitor using the computer sometimes remains unused on account of lack of knowledge about the existence of this facility.

It is therefore an object of the present invention to specify a method and a system for configuring a monitor where these are simple and intuitive to use and provide convenient control facilities. It is also an object of the present invention to describe a computer, a monitor and a graphics card which are able to be used to carry out the inventive method.

This object is achieved by a method according to patent claim 1, a monitor according to claim 2, a computer according to claim 9, a graphics card according to claim 10 and a system according to claim 13.

In line with the invention, the method for configuring a monitor comprises the following steps: following operation of an input facility on the monitor, a control signal is generated by a control signal generator in the monitor. The control signal is transferred from the monitor to a computer and is detected there by a control signal detector in the computer. Next, a configuration program, executed by the computer, for the remote configuration of the monitor is activated by the computer.

The control signal which is transferred from the monitor to the computer and which is detected there allows the configuration of the monitor to be activated in the manner to which the user is accustomed, namely by operating the input facility on the monitor, even in the case of remote configuration of the monitor by the computer.

Advantageous refinements and developments of the invention are the subject matter of the dependent claims.

The invention is explained in more detail below using an exemplary embodiment with reference to two figures, in which:

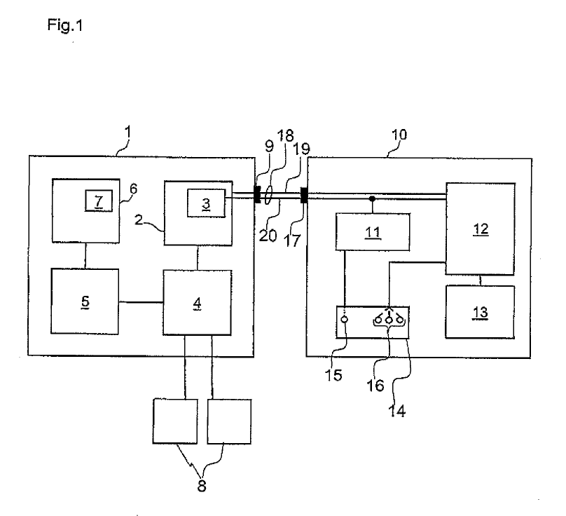

FIG. 1 shows an exemplary embodiment of an inventive system comprising a computer and a monitor, and

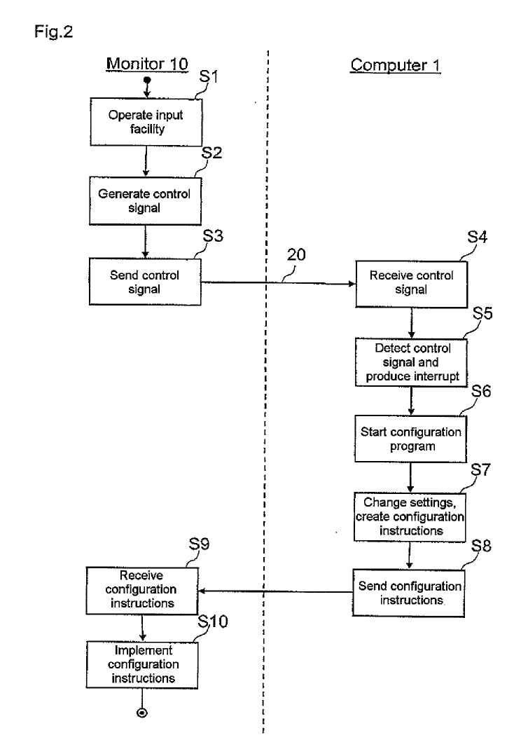

FIG. 2 shows a flowchart for an exemplary embodiment of the inventive method for configuring a monitor.

FIG. 1 schematically shows a computer 1 with a graphics card 2 which has a control signal detector 3. The computer 1 also comprises an input and output unit 4 connected to the graphics card 2 and also a processor 5 connected to said input and output unit. The processor 5 has access to a memory 6, the memory 6 containing a configuration program 7. The input and output unit 4 connects input devices 8 to the computer 1. The computer 1 also has a connection facility 9 for a monitor.

The system shown in FIG. 1 also comprises a monitor 10 which is connected to the computer 1 and which has a control signal generator 11, an image generator 12 connected thereto and a display unit 13 connected to the image generator 12. The monitor 10 also comprises an input facility 14 with a key 15 and also further keys 16. The key 15 is connected to the control signal generator 11, and the further keys 16 are connected to the image generator 12. The monitor 10 has a connection facility for computers 17 which is used to connect it to the connection facility for monitors 9 on the computer 1 using a monitor cable 18. The monitor cable 18 comprises image signal lines 19 and a control line 20.

From the computer 1, FIG. 1 shows only the components which are fundamental within the context of the invention. The presence of further components, e.g. a power supply unit or a non-volatile mass memory, is assumed to be obvious. The architecture shown for the computer 1 is also merely exemplary. The graphics card 2 may be either an expansion card for the computer 1 which is connected to an expansion interface, e.g. an AGP (Advanced Graphics Port) or a PCI (Peripheral Component Interconnect) express interface, which is provided on the computer's motherboard, or a unit integrated on the motherboard of the computer 1 (“onboard graphics”), for example.

During operation, the graphics card 2 in the computer 1 generates image signals which are transferred to the monitor 10 via one or more image signal lines 19 in the monitor cable 18. In the monitor 10, the image signals are conditioned by the image generator 12, so that an appropriate image is reproduced on the display unit 13. The display unit 13 may be either a cathode ray tube or an LCD (Liquid Crystal Display) or a plasma display. The image signal which is output by the graphics card 2 and which is processed via the image generator 12 may in this case be transferred either in analogue form or else digitally. Various standards have become established for the transfer and the signal form of the image signals, and in this context particular mention should be made of the VGA (Video Graphics Adapter) standard for analogue image signals and of the DVI (Digital Visual Interface) or HDMI (High Definition Media Interface) standard for digital image signals. The standards used also stipulate the mechanical and electrical interpretation of the connection facility for monitors 9 and of the connection facility for computers 17 and the monitor cable 18 connecting these two.

In line with the invention, the monitor 10 has the control signal generator 11, connected to the key 15 for the input facility 14. When the key 15 is operated by the user, the control signal generator 11 generates a control signal which is sent via the signal line 20 to the control signal detector 3 on the graphics card 2 in the computer 1. If the signal line 20 is used only for transferring the control signal from the monitor 10 to the computer 1 then a prescribed voltage level on the signal line 20 can be stipulated as the control signal.

A suitable specification for the control signal line 20 is the DDC standard from the VESA organization, particularly in its bidirectional interpretation (DDC2). This standard provides for possibly bidirectional, serial transfer via a signal line and, besides the signal form, likewise defines a suitable transfer protocol. The transfer protocol contains a facility for transferring user-specific commands or command sequences. To this end, the specification defines a command which initiates a user-specific command sequence and hence identifies it as such. The control signal stipulated may therefore be a predetermined command sequence.

Since the remote configuration of the monitor 10 using the computer 1 is usually likewise handled via a control line based on the DDC specification (in that case sometimes in its unidirectional variant), the transfer of the control signal from the control signal generator 11 from the monitor 10 to the computer 1 can be implemented without the need for extensive additions to the hardware for the transfer path between the computer 1 and the monitor 10.

In the computer 1, the signals transferred via the control signal line 20 are received and evaluated. When the control signal is detected by the control signal detector 3, it outputs an interrupt request (interrupt call) within the computer 1. If the control signal stipulated is a predetermined command sequence, the control signal detector 3 is set up to convert a received signal into a command sequence on the basis of the transfer protocol and to compare it with the predetermined command sequence.

The computer 1 is set up such that the processor 5, upon receiving the interrupt request, executes the configuration program 7 which is in the memory 6. The linking of particular events, in this case the execution or activation of the configuration program 7, to predetermined interrupt requests is known from the prior art and is organized in the computer 1 usually by a BIOS (Basic Input Output System) or an operating system. The configuration program 7 which is then executed on the computer 1 provides the user with a convenient way of changing settings for the monitor 10 using the input devices 8, that is to say the keyboard and/or mouse, for example. As is known from the prior art, the changed settings are transferred as configuration instructions via the control signal line 20 to the monitor 10, where they are evaluated and implemented.

The transfer of configuration instructions from the computer 1 to the monitor 10 via the control signal line 20 may likewise be handled by the control signal detector 3, which for this purpose has not only a reception device for the control signal but also an appropriate transmission device for the configuration instructions. Alternatively, a separate transmission device (not shown here) may be arranged on the graphics card 2 or at another location within the computer 1, which transmission device, like the control signal detector 3, is connected to the control signal line 20.

In the example shown, the image generator 12 undertakes the evaluation and implementation of the configuration instructions in the monitor 10. Alternatively, a separate unit may naturally be provided in the monitor 10 for this purpose. The inventive method which has just been outlined is explained in more detail further below in connection with FIG. 2.

In the exemplary embodiment shown, the further keys 16 provide the monitor 10 with an additional configuration facility inside the monitor. The keys 16 can be used to show an OSD configuration menu on the display unit 13 by means of the image generator 12 and to operate it. The additional, internal configuration facility is optional and serves particularly to make the monitor compatible with computers which do not support remote configuration. In another embodiment of the monitor 10, the key 15 can be dispensed with and the control signal generator 11 can be activated by an appropriate option within the configuration program inside the monitor.

Another conceivable alternative is for the monitor 10 to be able to be operated using a remote control and for input facilities corresponding to the keys 15 and/or 16 to be provided by means of the remote control.

FIG. 2 shows the flow of an exemplary embodiment of the inventive method in more detail with the aid of a flowchart.

In a step S1, an input facility on the monitor 10 is operated by the user. As already explained, this may be either a direct input facility in the form of the key 15 or an indirect input facility via an OSD configuration menu inside the monitor.

In a step S2, the control signal generator 11 in the monitor 10 then generates a predetermined command sequence as a control signal on the basis of a transfer protocol defined for the control signal line 20.

This control signal is sent to the computer 1 via the control signal line 20 in step S3.

The control signal is received by the computer 1 in step S4 and is detected by the control signal detector 3 in the graphics card 2 in step S5. For this purpose, the control signal detector 3 continually monitors the control signal line 20 and analyzes transferred signals using the underlying transfer protocol. When the predetermined control signal occurs, the control signal detector 3 outputs an appropriate interrupt request, which is likewise predetermined.

This interrupt request acts on the processor 5 via the input and output unit 4. The exact mechanisms of the transfer and reaction to an interrupt request are dependent on the underlying architecture of the computer 1. In a step S6, the processor 5 then starts the configuration program 7 or, if this has already been executed in a background process, activates it and executes it as a foreground process. As a result, the user's user interface (“desktop”) and hence the monitor 10 show the user interface of the configuration program 7 for remote configuration of the monitor 10.

In step S7 of the method, the user can use the latter user interface to make changes to the settings of the monitor 10. On the basis of the changed settings, configuration instructions are then transferred from the configuration program 7 to the monitor 10 in step S8.

In a step S9, the monitor 10 receives the transferred configuration instructions, which are evaluated and implemented in a step S10. Implementation means that settings for the monitor 10 are changed on the basis of the configuration instructions. In the exemplary embodiment shown in FIG. 1, this is done by the image generator 12, which also manages the configuration settings.

### LIST OF REFERENCE SYMBOLS

1 Computer
2 Graphics card
3 Control signal detector
4 Input and output unit
5 Processor
6 Memory
7 Configuration program
8 Input device
9 Connection facility (for monitors)
10 Monitor
11 Control signal generator
12 Image generator
13 Display unit
14 Input facility
15 Key
16 Further keys
17 Connection facility (for computers)
18 Monitor cable
19 Image signal line
20 Control signal line

1. A method for configuring a monitor comprising the steps of:
operating an input facility on the monitor;
generating a control signal by a control signal generator in the monitor;
transferring the control signal from the monitor to a graphics card of a computer;
detecting the control signal is detected by a control signal detector in the graphics card;
generating an interrupt request by the graphics card; and
executing a configuration program by the computer, in response to the interrupt request, for configuring the monitor.

2. A monitor comprising:
a connection facility for a computer designed on the basis of a VESA specification and having a connection for a DDC or DDC2 data channel, the connection facility being adapted to be used for transferring control signals between the monitor and the computer;
an input facility on the monitor; and
a control signal generator connected to the input facility and the connection facility,
wherein the control signal generator is configured so that when the input facility is operated it generates a control signal and outputs the control signal on the connection for the DDC or DDC2 data channel of the connection facility, so that a method according to claim 1 can be carried out.

3. The monitor according to claim 2, wherein a key is provided as the input facility, with operation of the key resulting directly in generation of the control signal by the control signal generator.

4. The monitor according to claim 3, wherein at least one further key is provided, the at least one further key being used to control a screen menu which can likewise be used to configure the monitor.

5. The monitor according to claim 2, wherein at least one key for controlling a screen menu is provided, and the input facility is produced by means of the screen menu such that an appropriate selection in the screen menu results in generation of the control signal by the control signal generator.

6. The monitor according to claim 5, wherein the screen menu can likewise be used to configure the monitor.

7-9. (canceled)

10. A graphics card for use in a computer comprising:
a connection facility for a monitor designed on the basis of a VESA specification and having a connection for a DDC or DDC2 data channel, the connection facility being adapted to be used for transferring control signals between the graphics card and the monitor; and,
a control signal detector connected to the connection facility;
wherein the control signal detector is adapted to receive signals on the connection for the DDC or DDC2 data channel of the connection facility and, following detection of a prescribed control signal on the connection facility, to send a predetermined interrupt request to the computer which is adapted for bringing about execution of the configuration program by the computer so that a method according to claim 1 can be carried out.

11-12. (canceled)

13. A system, comprising:
a monitor comprising:
a connection facility for a computer designed on the basis of a VESA specification and having a connection for a DDC or DDC2 data channel, the connection facility being adapted to be used for transferring control signals between the monitor and the computer;
an input facility on the monitor; and
a control signal generator connected to the input facility and the connection facility,
wherein the control signal generator is configured so that when the input facility is operated it generates a control signal and outputs the control signal on the connection for the DDC or DDC2 data channel of the connection facility; and
a computer with a graphics card comprising:
a connection facility for a monitor designed on the basis of a VESA specification and having a connection for a DDC or DDC2 data channel, the connection facility being adapted to be used for transferring control signals between the graphics card and the monitor; and,
a control signal detector connected to the connection facility;
wherein the control signal detector is adapted to receive signals on the connection for the DDC or DDC2 data channel of the connection facility and, following detection of a prescribed control signal on the connection facility, to send a predetermined interrupt request to the computer which is adapted for bringing about execution of the configuration program by the computer; and
wherein the monitor and computer are adapted for carrying out the method according to claim 1.
